(19) United States
(12) Patent Application Publication
(10) Pub. No.: US 2022/0351927 A1
(43) Pub. Date: Nov. 3, 2022

(54) METHOD AND SYSTEM FOR PROVIDING A PREDETERMINED PYROTECHNIC ENERGY OUTPUT

(71) Applicant: RUAG Ammotec GmbH, Fürth (DE)

(72) Inventors: Andreas WINTER, Fürth (DE); Ulf LAWRENTZ, Fürth (DE); Ulrich BLEY, Fürth (DE)

(21) Appl. No.: 17/763,372

(22) PCT Filed: Aug. 26, 2020
(86) PCT No.: PCT/EP2020/073837

§ 371 Date: Mar. 24, 2022

(30) Foreign Application Priority Data
Sep. 27, 2019 (DE) 10 2019 126 192.9

(51) Int. Cl. H01H 37/76; H01H 35/14; B23D 15/14

(52) U.S. Cl. CPC H01H 37/76; H01H 35/14; B23D 15/145

(57) ABSTRACT

Summary

The present invention relates to a process for providing a predetermined pyrotechnic energy output, comprising a pyrotechnic material that pyrotechnically converts at a material-specific conversion temperature, and communicating heat to the pyrotechnic material to convert the pyrotechnic material at an ambient temperature of the pyrotechnic material that is less than the conversion temperature.

The present invention relates to a process and a system for providing a predetermined pyrotechnic energy output, in particular of at least 0.5 J.

Generic pyrotechnic actuators for pyrotechnic cutting devices, explosives have proved to be advantageous whose conversion temperatures are well above 100° C., in particular above 170° C. or even above 300° C. However, a temperature-related conversion of the explosives should continue to take place at below 100° C., in particular at about 90° C. This ensures the functionality of the pyrotechnic actuator over long periods and avoids false activations. False activations are generally due to aging effects of the explosive, which occur more rapidly the closer the conversion temperature of the explosive is to the expected storage and/or use temperatures. Furthermore, aging effects of the explosives also very often lead to a strong reduction of the effect or even to a total failure of the pyrotechnic actuator.

So-called emergency cutting mechanisms for batteries, which are intended to prevent overheating of the batteries, are known in the prior art. For example, DE 20 2006 020 172 U1 discloses a current interrupter for battery cables of motor vehicles, which is accommodated within the pole niche of the motor vehicle battery or a fuse box within the line network. The circuit breaker comprises two electrical connection sections in contact with each other, which can be moved away from each other by repositioning a pyrotechnic material to break the electrical connection. It has been found to be disadvantageous that the electrical connection sections are removed from each other in an undefined and uncontrolled manner. Further, it has been found to be a disadvantage of such a current interrupter that the two electrical connection sections tend to come back into contact with each other on their own so that electrical conductivity is restored. This can cause significant damage to the components coupled to the battery. Finally, the circuit breaker is also severely limited in terms of attachment to an electrical energy source. Another disadvantage is that such a current interrupter tends to backfire when electrically actuated.

It is the objective of the present invention to improve the disadvantages of the known prior art, in particular to provide a reliable and functionally safe process or system for providing a predetermined pyrotechnic energy output, in which backfire are avoided and/or a controlled energy output is made possible.

The objective is solved by the object of claims 1, 11, 16 and 29, respectively.

In accordance with a first aspect of the present invention, there is provided a process for providing a predetermined pyrotechnic energy output of preferably at least 0.5 J. Pyrotechnic energy output is used, for example, in pyrotechnic cutting devices, pyrotechnic switching devices or active devices adapted to disconnect, cut, punch, damage or the like an electric line, such as a cable, a wire, a conductor path, or the like, leading to an electrical energy source, such as a battery, a galvanic cell or an accumulator, for discharging and/or receiving electrical energy. Such pyrotechnic cutting devices are designed to disconnect an electrical charging coupling between an electrical energy source and an electrical energy supply, or an electrical end charging coupling between a preferably chargeable energy source and an electrical load. For example, the pyrotechnic cutting device is intended to prevent overheating on electronic devices, in particular of batteries, such as lithium-ion batteries, which can lead to damage to the electronic device. Such batteries can provide a current strength of significantly more than 1 A, particularly in a range from 1 A to 70 A, especially in a range from 10 A to 50 A, especially in a range from 10 A to 30 A or a range from 30 A to 50 A, or in a range from 50 A to 70 A, for example 45 A, 35 A or 40 A. Pyrotechnic cutting devices can also be designed such that they can be used to separate an electrically conductive conductive path leading to a carrier for electronic components, in particular a printed circuit board, circuit card or circuit board, or electrically conductive paths provided therein for dissipating and/or receiving electrical energy. Generic pyrotechnic cutting devices are known from German application DE 10 2019 101 430.1 of the same applicant, the contents of which, particularly with respect to the operation and design of pyrotechnic cutting devices, are fully incorporated herein by reference.

According to the process according to the invention, a pyrotechnic material is provided which pyrotechnically converts at a material-specific conversion temperature. Preferably, pyrotechnic materials are provided whose conversion temperatures are significantly above 100° C., in particular above 110° C., 120° C., 130° C., 140° C., 150° C., or even above 170° C., 200° C., 220° C. or above 250° C., in particular above 300° C.

For example, the potassium salt of 1,4-dihydro-5,7-dinitrobenzofurazan-4-ol 3-oxide (short: potassium dinitrobenzofuroxanate, K-benzanate, or KDNBF), K/Ca 2,4,6-trinitrobenzene-1,3-bis(olate) (short: Potassium/calcium styphnate, K/CaStyp) or lead 2,4,6-trinitroresorcinate (in short: lead trizinate, lead styphnate, trizinate) are used as components of the pyrotechnic material. The mentioned substances can be used in mixtures with other components. The melting point or decomposition point of, for example, pure KDNBF is about 170° C. In mixtures of KDNBF with selected components, the deflagration temperatures can be controlled within the range of 150° C. to 160° C., and the deflagration temperatures of the mixtures can be lower than those of the individual components. Further suitable materials can be found in the German publication DE 102006060145 A1 of the applicant.

Furthermore, primary explosives can be used individually or in combination with additives to achieve higher efficacy. Examples include diazodinitrophenol (in short: diazole, dinol, or DDNP), salts of styphinic acid (such as K/Ca 2,4,6-trinitrobenzene-1,3-bis(olate) (in short: potassium/calcium styphnate, K/CaStyp) or lead 2,4,6-trinitroresorcinate (in short: Lead trizinate, lead styphnate, trizinate)), tetrazene, salts of dinitrobenzofuroxanate, 1-(2,4,6-trinitrophenyl)-5-(1-(2,4,6-trinitrophenyl)-1H-tetrazol-5-yl)-1H-tetrazole (short: picrazole), or N-methyl-N-2,4,6-tetranitroaniline (short: tetryl).

For example, K/Ca 2,4,6-trinitrobenzene-1,3-bis(olate) (potassium/calcium styphnate, K/CaStyp for short) can be used as a pyrotechnic material. Other suitable pyrotechnic materials are described, for example, in the publication EP 1 890 986 Bi, which goes back to the international patent application WO 2006/128910 and the German patent applications DE 10 2005 025 746 and DE 10 2006 013 622, which are intended to be incorporated by reference into the disclosure content of the present invention.

Furthermore, according to the process of the invention, heat is communicated to the pyrotechnic material for conversion of the pyrotechnic material at an ambient temperature of the pyrotechnic material, which is lower than the conversion temperature of the pyrotechnic material. In many applications, it happens that a temperature-related conversion of the pyrotechnic material is to take place at below 100° C., in particular at about 90° C. In general, the process according to the invention comes into play when a pyrotechnic conversion for providing a predetermined pyrotechnic energy output is already to take place, in particular is to take place at an ambient temperature of the pyrotechnic material, when the conversion temperature of the pyrotechnic material has not yet been reached, in particular when the ambient temperature is still lower than the pyrotechnic conversion temperature. By means of the process according to the invention, it is possible to continue to use the proven materials that react at high conversion temperatures, in particular well above 100° C., so that the functionality of a pyrotechnic system is ensured over long periods of time and false activations are avoided, as well as a reliable and controlled pyrotechnic energy output is ensured.

In an exemplary embodiment of the present invention, the pyrotechnic material is heated to at least partially reach the material-specific conversion temperature. In other words, it is possible that the pyrotechnic material is not necessarily heated in such a way that a temperature difference between the conversion temperature and the ambient temperature is completely bypassed, in particular exceeded.

According to an exemplary further development of the process according to the invention, the pyrotechnic material is heated in such a way that a temperature difference between the conversion temperature and the ambient temperature is completely bypassed, in particular exceeded. Preferably, the pyrotechnic material is heated in such a way that the conversion temperature is exceeded by at least 5° C., at least 10° C., at least 15° C., at least 50° C., at least 70° C. or by at least 90° C. This ensures that the pyrotechnic energy output is reliably delivered. This also includes the exemplary embodiment that the pyrotechnic material is heated locally, selectively and/or regionally so that the pyrotechnic material reaches its material-specific conversion temperature locally, selectively and/or regionally. Reaching the material-specific conversion temperature in the heated area results in a kind of chain reaction, in particular insofar as the pyrotechnic material converts in this area or locally, which results in the remaining, previously unheated pyrotechnic material also being heated and brought to the conversion.

According to another exemplary embodiment of the present invention, the heat communicated to the pyrotechnic material is generated by an exothermic chemical reaction. An exothermic chemical reaction is generally understood to be a reaction that produces more heat than was initially supplied to it as activation or trigger energy.

According to an exemplary further development of the process according to the invention, a reaction substance and a reaction partner substance are at least partially mixed, preferably under exothermic chemical reaction, to generate the heat. For example, the reaction substance and the reaction partner substance are provided in such a way that, in order to react the pyrotechnic material, the two substances are mixed with one another so that heat is generated under an exothermic chemical reaction between the two substances, which heat is communicated to the pyrotechnic material so that the latter is heated to at least partially reach the reaction temperature, in particular is heated in such a way that the reaction temperature is completely reached or exceeded.

According to an exemplary further development of the process according to the invention, the reaction substance is selected from a list comprising glycerol (propane-1,2,3-triol), zinc powder, ammonium nitrate, ammonium chloride and/or lithium aluminum hydride (LiAlH₄). Further, it may be provided that the reaction partner substance is selected from a list comprising potassium permanganate (KMnO₄), water and/or methanol (CH₃OH). As preferred combinations of specific reaction substances and reaction partner substances, glycerol as reaction substance and potassium permanganate as reaction partner substance, zinc powder and/or ammonium nitrate (NH₄NO₃) and/or ammonium chloride (NH₄Cl) as reaction substance in combination with water or methanol as reaction partner substance, and lithium aluminum hydride as reaction substance in combination with water as reaction partner substance have proven advantageous.

In another exemplary embodiment of the process according to the invention, a boundary separating the reaction substance and the reaction partner substance from each other, such as a partition, is melted, broken, cut or the like to communicate the heat to the pyrotechnic material. For example, the reaction substance and the reaction partner substance may be provided in a common enclosure and/or separated from each other by a boundary. In this regard, the boundary may comprise a portion of the housing wall, such as a coating. For example, the boundary is also surrounded by the housing wall. Furthermore, it may be provided that one of the two substances is arranged in the housing, while the respective other substance completely surrounds the housing, in particular.

In a further exemplary embodiment of the process according to the invention, the heat is communicated to the pyrotechnic material when a predetermined threshold of a kinetic and/or thermal energy input acting on the pyrotechnic material is exceeded and, for example, it may be provided that an energy input threshold is predetermined with respect to the pyrotechnic material. By predetermining the energy input threshold, the conversion of the pyrotechnic material can be indirectly controlled. This is because exceeding the predetermined energy input threshold can be understood as a condition or trigger parameter for communicating heat to the pyrotechnic material. In other words, no heat is supplied to the pyrotechnic material as long as the energy input remains below the predetermined energy input threshold.

According to an exemplary further development, the energy input threshold is realized by a temperature threshold and/or an acceleration force threshold. For example, the temperature threshold may be a threshold for an ambient temperature of the pyrotechnic material. Furthermore, the energy input threshold can also be realized by a threshold of an acceleration force acting on the pyrotechnic material, in particular negative acceleration force.

In another exemplary embodiment of the present invention, the communicating of heat to the pyrotechnic material is electrically triggered. For example, the electrical triggering may be provided as a redundant triggering option. For example, the electrical triggering may set a temperature responsible for communicating heat to the pyrotechnic material. For example, it may be provided that the electrical triggering causes a reaction substance and a reaction partner substance to be mixed. For example, this may be realized by the electrical triggering causing a fracturing and/or melting of a boundary separating the reaction substance from the reaction partner substance. According to an alternative embodiment, it may be provided that the electrical triggering is a necessary criterion for heat to be communicated to the pyrotechnic material.

According to a further aspect combinable with the preceding aspects and exemplary embodiments, a process for triggering a pyrotechnic actuator is provided. For example, a pyrotechnic actuator may be used in a pyrotechnic cutting device that may be adapted to disconnect an electric line, such as a cable, wire, conductive path, or the like, leading to an electrical energy source, such as a battery or accumulator, for dissipating and/or receiving electrical energy. Such pyrotechnic cutting devices are designed to disconnect an electrical charging coupling between an electrical energy source and an electrical energy supply, or an electrical final charging coupling between a preferably chargeable energy source and an electrical load. For example, the pyrotechnic cutting device is intended to prevent overheating on electronic devices, in particular of batteries, such as lithium-ion batteries, which can lead to damage to the electronic device. Pyrotechnic cutting devices can also be designed in such a way that they can be used to disconnect a conductor that is connected to a carrier for electronic components, in particular a printed circuit board, circuit card or circuit board, or electrically conductive conductor paths provided therein for dissipating and/or receiving electrical energy. The pyrotechnic actuator may be set to operate a cutting mechanism of the pyrotechnic cutting device to cap the electrical conduction. For example, the pyrotechnic actuator may be set to perform the mechanical work to cut the electric line by the cutting mechanism using the pyrotechnic effect of the pyrotechnic actuator. The pyrotechnic actuator may be associated with the cutting mechanism such that the cutting mechanism is driven or operated when the pyrotechnic actuator is activated. In particular, the cutting mechanism disconnects the electric line when the pyrotechnic actuator is activated. Accordingly, the pyrotechnic actuator utilizes the pyrotechnic effect to provide the cutting mechanism having a driving, accelerating, or actuating force by means of which the cutting mechanism can perform mechanical work to sever the electric line. It should be understood that the drive is not limited to the described application for cutting an electric line. For example, a gyroscope can be set in rotation or, in the case of an electrical fuse, a bolt can be driven for locking or unlocking.

According to the process according to the invention, the pyrotechnic actuator is triggered when a kinetic and/or thermal energy input acting on the pyrotechnic actuator exceeds a predetermined energy input threshold. For example, the initiation of the pyrotechnic actuator may be accompanied by a pyrotechnic energy output. For example, the pyrotechnic actuator experiences a kinetic energy input when the pyrotechnic actuator is moved and/or a movement of the pyrotechnic actuator is preferably abruptly interrupted. The thermal energy input to the pyrotechnic actuator may be realized, for example, by the ambient temperature of the pyrotechnic actuator. For example, the process may provide that the pyrotechnic actuator is triggered exclusively when the energy input threshold is exceeded.

In an exemplary embodiment of the process according to the invention, initiation of the pyrotechnic actuator is triggered by a mechanical application of force to the pyrotechnic actuator. For example, the pyrotechnic actuator may comprise a mechanical primer and the force input may be provided by a striker. For example, the mechanical force input is provided by a conversion of potential energy to kinetic energy and/or by a change in kinetic energy. According to an exemplary further development, the mechanical force required to trigger the initiation of the pyrotechnic actuator can be temporarily stored, for example by a force storage implemented by a spring biasing force in particular, and when the predetermined energy input threshold is exceeded, the temporarily stored mechanical force can be released, preferably abruptly. The temporarily stored mechanical force can preferably be temporarily stored or made available in such a way that the force is immediately available for triggering the pyrotechnic actuator when the predetermined energy input threshold is exceeded and can be transmitted immediately to the pyrotechnic actuator.

According to an exemplary further development, the energy input threshold is realized by a temperature threshold and/or an acceleration force threshold. For example, the temperature threshold may be a threshold for an ambient temperature of the pyrotechnic material. Furthermore, the energy input threshold can also be realized by a threshold of an acceleration force acting on the pyrotechnic material, in particular negative acceleration force.

In another exemplary embodiment of the present invention, exceeding the predetermined energy input threshold is electrically triggered. For example, the electrical triggering may be provided as a redundant triggering option. For example, the electrical triggering may set a temperature responsible for exceeding the temperature threshold. For example, it may be provided that the electrical triggering causes a reaction substance and a reaction partner substance to be mixed. For example, this may be realized by the electrical triggering causing a fracture and/or melting of a boundary separating the reaction substance from the reaction partner substance.

According to an exemplary further embodiment of the process according to the invention, the process proceeds according to the operation of the system formed according to any of the exemplary aspects or exemplary embodiments below for providing a predetermined pyrotechnic energy output.

According to another aspect of the present invention, which is combinable with the preceding aspects and exemplary embodiments, a system for providing a predetermined pyrotechnic energy output, in particular of at least 0.5 J, is provided. Systems according to the invention may, for example, be part of a pyrotechnic actuator and/or comprise a pyrotechnic actuator. Furthermore, systems according to the invention can serve, for example, to provide a pyrotechnic energy output for a pyrotechnic cutting device for separating an electrical charging coupling or an electrical final charging coupling between an electrical energy source and an electrical consumer. Pyrotechnic energy output is used, for example, in pyrotechnic cutting devices arranged to disconnect an electric line, such as a cable, wire, conductor path, or the like, leading to an electrical energy source, such as a battery or accumulator, for discharging and/or receiving electrical energy. Such pyrotechnic cutting devices are designed to disconnect an electrical charging coupling between an electrical energy source and an electrical energy supply, or an electrical final charging coupling between a preferably chargeable energy source and an electrical load. For example, the pyrotechnic cutting device is intended to prevent overheating on electronic devices, in particular of batteries such as lithium-ion batteries, which may result in damage to the electronic device. Such batteries can provide a current strength of well over 1 A, in particular up to 10 A or 50 A. Pyrotechnic cutting devices can also be designed such that they can be used to disconnect a conductor that is connected to a carrier for electronic components, in particular a printed circuit board, circuit card or circuit board, or electrically conductive conductors provided therein for dissipating and/or receiving electrical energy.

The system according to the invention comprises pyrotechnic material or pyrotechnic material that pyrotechnically converts when a pyrotechnic material-specific conversion temperature is reached. Preferably, pyrotechnic materials are provided whose conversion temperatures are significantly above 100° C., in particular above 110° C., 120° C., 130° C., 140° C., 150° C., or even above 170° C., 200° C., 220° C. or above 250° C., in particular above 300° C.

Further, the system according to the invention comprises a heat source for delivering heat to the pyrotechnic material. For example, the heat source and the pyrotechnic material are surrounded by a common housing or chamber. Preferably, the chamber is pressure, gas and fluid tight. The heat source may be arranged to store a predetermined amount of energy and/or heat and/or to deliver stored heat and/or energy to the pyrotechnic material at a predetermined time of operation, preferably to convert the pyrotechnic material.

According to the invention, the system includes a control mechanism associated with the heat source for triggering the predetermined pyrotechnic energy output. The control mechanism serves to ensure that the predetermined pyrotechnic energy output is reliably provided. When the system according to the invention is used in a pyrotechnic cutting device, the control mechanism can be used to reliably ensure that the pyrotechnic cutting device reliably cuts or caps the electric line conducting the electrical charge coupling and/or discharge coupling. At a predetermined operating condition in which an ambient temperature of the pyrotechnic material has not yet reached the conversion temperature, the control mechanism acts on the heat source to release its stored heat to the pyrotechnic material such that the pyrotechnic material is heated to at least partially reach the conversion temperature. The system according to the invention has proven to be particularly advantageous when, on the one hand, pyrotechnic materials having high conversion temperatures are to be used in order to ensure the functionality of the pyrotechnic material over long periods of time and to avoid false activations and, on the other hand, pyrotechnic conversion is to take place already at lower temperatures. By means of the system according to the invention, it is possible to continue to use the proven materials that react at high conversion temperatures, in particular well above 100° C., so that the functionality of a pyrotechnic system is ensured over long periods of time and false activations are avoided as well as a reliable and controlled pyrotechnic energy output is ensured.

In an exemplary embodiment of the system according to the invention, the heat stored in the heat source is set in such a way that, when the heat source is activated, it completely bridges, in particular exceeds, a temperature difference between the conversion temperature and the ambient temperature, preferably by at least 5°, at least 10°, at least 15° or at least 50°. In other words, the stored heat is adjusted such that an activation of the heat source by the control mechanism causes a conversion of the pyrotechnic material, in particular without the need for further heat and/or energy input. In this way, the system according to the invention can ensure reliable delivery of the pyrotechnic energy. The heat source can be designed, or the energy stored therein can be adjusted, in such a way that the system according to the invention and/or the heat source is designed and/or dimensioned and/or adjusted as a function of the framework conditions in which it is used. As a rule, the pyrotechnic material-specific conversion temperature of the pyrotechnic material used is known. Furthermore, it is possible to estimate or guess the ambient temperatures to which the system according to the invention or the pyrotechnic material will be exposed. Knowing these two temperatures, the heat source can be designed or adjusted in such a way that the temperature difference between the reaction temperature and the ambient temperature is at least bypassed, in particular significantly exceeded, in order to provide a functionally reliable system.

According to an exemplary further development of the system according to the invention, the heat source comprises an energy carrier containing chemical energy. For example, the chemical energy carrier can be accommodated and/or stored in a housing or capsule. Activation of the heat source, in particular the energy carrier, causes an exothermic chemical reaction of the energy carrier. Exothermic chemical reaction is generally understood to mean a reaction to which less energy is supplied for its activation than the reaction releases or emits in energy. The energy carrier can be a chemical substance, for example.

In another exemplary embodiment of the system according to the invention, the heat source comprises a reaction substance, wherein in particular the reaction substance forms the energy carrier comprising the chemical energy. The heat source may further comprise a reaction partner substance. The reaction substance is separated from the reaction partner substance arranged in the heat source or outside the heat source, in particular separated in such a way that no mixing and/or contacting between the reaction substance and the reaction partner substance occurs, at least until the control mechanism triggers the predetermined pyrotechnic energy output. When the heat source is activated, in particular when the control mechanism acts on the heat source, mixing of the reaction substance and reaction partner substance occurs, so that an exothermic chemical reaction is triggered. Providing the pyrotechnic energy output can be accomplished, for example, by a chain reaction: Action of the control mechanism at a predetermined operating condition on the heat source; at least partial mixing of the reaction substance and the reaction partner substance; exothermic chemical reaction between the reaction substance and the reaction partner substance, releasing heat stored in the heat storage device and/or energy generated by the exothermic chemical reaction; communicating the released stored heat to the pyrotechnic material and reacting the pyrotechnic material; and pyrotechnic energy output.

According to an exemplary embodiment of the present invention, the heat source comprises a reaction substance and a partner substance disposed separately therefrom. The reaction substance may comprise glycerol, zinc powder, ammonium nitrate, ammonium chloride, and/or lithium aluminum hydride. The reaction partner substance may comprise, for example, potassium permanganate, water and/or methanol. The following in particular have been found to be advantageous as suitable combinations of reaction substance and reaction partner substance: Glycerol and potassium permanganate; zinc powder, ammonium nitrate, ammonium chloride and water or methanol; or lithium aluminum hydride and water.

According to another exemplary embodiment of the present invention, the heat source comprises a reaction substance and a reaction partner substance, wherein the reaction substance is separated from the reaction partner substance disposed in the heat source or outside the heat source. The heat source comprises a housing for containing the reaction substance and optionally the reaction partner substance. For example, the reaction substance is separated from the reaction partner substance by the housing, in particular the housing wall. In the event that the reaction partner substance is also arranged in the housing of the heat source, the heat source has a boundary separating the reaction substance from the reaction partner substance, for example a boundary. The housing, in particular the housing wall and optionally the boundary, can/may be made of glass, plastic or metal, in particular a metal alloy, such as a Rose alloy. According to an exemplary further development of the system according to the invention, the housing and optionally the boundary is/are designed in such a way that, in the predetermined operating state a mixing of the reaction substance and the reaction partner substance is accompanied. This can occur, for example, by the housing and/or optionally the boundary melting, breaking or the like.

A gas bubble, in particular an air bubble, can be provided inside the heat source, with which the activation of the heat source can be adjusted to a predetermined temperature, in particular with a tolerance of +/−2° C. The heat source, in particular its housing, which may be made of glass, for example, is filled for the most part with the reaction substance, in particular a liquid one. As the temperature rises, the liquid reaction substance expands. At the same time, the gas bubble also expands. The liquid reaction substance may be selected to be non-compressible, so that the liquid reaction substance compresses the gas bubble as a result of its volume expansion. The heat source, in particular its housing made of glass, for example, expands less, in particular by a multiple less, in particular by a negligible amount, compared to the liquid reaction substance and/or the gas bubble, so that an internal volume of the heat source, in particular of the housing, remains approximately constant. In general, there is a pressure equilibrium between the liquid reaction substance and, in particular, the compressed gas bubble, and the pressure in the internal volume increases with increasing temperature, since the total volume is approximately constant, but the gas volume decreases. In an exemplary embodiment, the gas bubble disappears completely and/or the gas of the gas bubble dissolves completely in the liquid reaction substance.

The strength of the heat source, in particular of the housing, which is for example a glass tube or a glass ampoule, can be determined by its material, in particular the type of glass, and the material thickness of the housing, in particular the glass tube. The pressure rising inside the housing, in particular the glass tube, can exceed a load limit of the housing, which leads to an in particular abrupt destruction, in particular shattering, of the housing. In particular, the material glass has proven to be advantageous, since it is hard and hardly yields under mechanical stress, but shatters abruptly.

For example, the trigger temperature can be set via the dimensioning and/or material selection of the housing. In particular, it is possible to adjust the internal pressure that will cause the housing to break. In particular, this depends on the properties of the housing. Especially for high volume production, it would be possible to set the trigger temperature via glass type and wall thickness.

The gas bubble, in particular its size and the type of specific gas, also has a non-negligible effect on the trigger temperature. In particular, it is true that gas bubbles of different sizes provide a different volume and/or expansion reserve for the liquid reaction substance and thus set different temperatures for the critical internal pressure that causes the housing to break. However, it is also conceivable to dispense with the gas bubble completely. Accordingly, one way to adjust the trigger temperature is to keep the housing essentially constant, for example, constant material selection and/or constant material thickness selection, but at the same time to vary the size of the gas bubble for this purpose. Accordingly, the liquid reaction substance can be filled into the housing of the heat source, whereby the filled-in amount of the liquid reaction substance determines the size, in particular the volume, of the resulting gas bubble. After the filling process, the housing of the heat source, in particular the glass tube or the glass ampoule, can be closed, in particular melted shut. The size of the gas bubble determines the expansion behavior, in particular the expansion reserve or the available volume by which the liquid reaction substance can expand. Similarly, the gas bubble thus determines the temperature required to break the housing, in particular the temperature at which equilibrium pressure in the housing, in particular in the glass tube, reaches the bursting pressure of the material of the housing, in particular glass.

Furthermore, one possibility for adjusting the trigger temperature is to vary the coefficient of expansion of the liquid reaction substance, in particular to vary the specific liquid reaction substance. This also makes it possible to influence the internal pressure inside the housing.

In another exemplary embodiment of the system according to the invention, the heat source has a reaction substance and a reaction partner substance arranged separately therefrom. The reaction partner substance is present with respect to the reaction substance in a ratio of at least 1:1, preferably at least 1.5:1 or at least 2:1. Furthermore, the ratio may be at most 5:1, preferably at most 4:1 or at most 3:1. In particular, the reaction partner substance is present with respect to the reaction substance in a ratio within the range from 1.5:1 to 2.5:1. The stated ratios ensure that sufficient reaction partner substance can mix or blend with reaction substance to reliably generate the exothermic chemical reaction. Furthermore, filler material can be added to the reaction and reaction partner substances. It has been found that the reaction substances tend to form solid or sticky residues that can prevent the exothermic reaction from continuing. The filler material can be such that solid and/or sticky residues are prevented, but only liquid or gaseous reaction residues are generated. This allows the chemical reaction to proceed more safely and the gas expansion to be carried out more reliably. For example, a quantitative ratio of reaction substance to filler is about 0.5:1.5, in particular about 0.8:1.2 or 1:1.

In another exemplary embodiment of the system according to the invention, the heat source comprises a reaction substance and a reaction partner substance arranged separately therefrom. It may be provided that the reaction partner substance and the pyrotechnic material are at least partially mixed. A mixing ratio of reaction partner substance to pyrotechnic material may be at least 10:1, in particular 15:1, at least 20:1 or at least 25:1. Due to the excess quantity, in the case of a mixed provision of reaction partner substance and pyrotechnic material, it is further ensured that sufficient reaction substance is present to trigger the exothermic chemical reaction when mixed with the reaction partner substance. The pyrotechnic material mixed with the reaction partner substance experiences an immediate local supply of heat upon activation of the heat source, in particular mixing of the reaction substance and the reaction partner substance, i.e. at those points or areas where the chemical reaction between the reaction substance and the reaction partner substance occurs, so that the pyrotechnic material reacts locally. The local conversion of parts of the pyrotechnic material again causes a kind of chain reaction. In this chain reaction, the other areas of the pyrotechnic material are also activated for its pyrotechnic conversion.

In another exemplary embodiment of the system according to the invention, the control mechanism activates the heat source when a predetermined threshold of a kinetic and/or thermal energy input acting on the control mechanism is exceeded. For example, the control mechanism is set to activate the heat source at a predetermined ambient temperature of the control mechanism and/or the pyrotechnic material. The control mechanism may further be formed by a kinetic energy and/or potential energy threshold. According to an exemplary further embodiment, the energy input threshold is implemented by a temperature threshold and/or an acceleration force threshold. For example, the temperature threshold may be a threshold for an ambient temperature of the pyrotechnic material. Furthermore, the energy input threshold can also be realized by a threshold of an acceleration force acting on the pyrotechnic material, in particular negative acceleration force.

According to an exemplary further development of the system according to the invention, the control mechanism is implemented by a predetermined temperature resistance threshold of the heat source. The temperature resistance threshold of the heat source can be understood, for example, as a material-specific temperature of the housing of the heat source. The temperature resistance threshold of the heat source housing is defined by the temperature up to which the housing remains stable and/or separates or shields the reaction substance from the reaction partner substance. When the temperature resistance threshold is exceeded, the heat source is activated, in particular by the housing or the boundary breaking or melting, so that mixing of the reaction substance and the reaction partner substance occurs. The mixing can cause an exothermic chemical reaction, as mentioned above.

According to an exemplary further embodiment of the system according to the invention, the control mechanism is implemented by an acceleration force threshold acting on the heat source, in particular negative acceleration force threshold. The negative acceleration force threshold may be exceeded, for example, in the event of an impact and/or abrupt stop. When the acceleration force threshold is exceeded, the heat source is activated, in particular by the housing and/or the boundary breaking, so that mixing of the reaction substance and the reaction partner substance occurs, in particular under exothermic chemical reaction.

In another exemplary embodiment of the system according to the invention, the control mechanism comprises an electrical primer element. In particular, the control mechanism is formed by the electrical primer element. The electrical primer element, in particular an electrical primer element formed as an electrical primer having a thermal or ignition bridge, is associated with the heat source in such a way that, upon electrical initiation of the electrical primer element, the heat source is activated. For example, it can be provided that the electrical primer element, in particular its ignition or thermal bridge, heats up in such a way that the housing or the boundary is destroyed in order to trigger mixing of the reaction substance and the reaction partner substance. For example, the electrical initiation element of the control mechanism may be connected in series with at least one other control mechanism option, such as exceeding a predetermined kinetic and/or thermal energy input threshold, such that electrical initiation of the electrical initiation element causes the energy input threshold to be exceeded so that, as a result, the heat source is activated to release its stored heat to the pyrotechnic material.

According to another aspect of the present invention, which is combinable with the preceding aspects and exemplary embodiments, there is provided a system for providing a predetermined pyrotechnic energy output.

The system according to the invention comprises a pyrotechnic actuator. The pyrotechnic actuator can be used, for example, in a pyrotechnic cutting device, which can be arranged to disconnect an electric line, such as a cable, a wire, a conductor path, or the like, leading to an electrical energy source, such as a battery or an accumulator, for discharging and/or receiving electrical energy. Such pyrotechnic cutting devices are designed to disconnect an electrical charging coupling between an electrical energy source and an electrical energy supply, or an electrical final charging coupling between a preferably chargeable energy source and an electrical load. For example, the pyrotechnic cutting device is intended to prevent overheating on electronic devices, in particular of batteries, such as lithium-ion batteries, which can lead to damage to the electronic device. Pyrotechnic cutting devices can also be designed in such a way that they can be used to disconnect a conductor that is connected to a carrier for electronic components, in particular a printed circuit board, circuit card or circuit board, or electrically conductive conductor paths provided therein for dissipating and/or receiving electrical energy. The pyrotechnic actuator may be set to operate a cutting mechanism of the pyrotechnic cutting device to cap the electrical conduction. For example, the pyrotechnic actuator may be set to perform the mechanical work to cut the electric line by the cutting mechanism using the pyrotechnic effect of the pyrotechnic actuator. The pyrotechnic actuator may be associated with the cutting mechanism such that the cutting mechanism is driven or operated when the pyrotechnic actuator is activated. In particular, the cutting mechanism disconnects the electric line when the pyrotechnic actuator is activated. The pyrotechnic actuator thus makes use of the pyrotechnic effect to provide the cutting mechanism with a driving, accelerating or actuating force by means of which the cutting mechanism can perform mechanical work in order to cut the electric line.

Furthermore, the system comprises a control mechanism for triggering the pyrotechnic actuator. The control mechanism triggers the pyrotechnic actuator when a kinetic and/or thermal energy input acting on the control mechanism reaches and/or exceeds a predetermined energy input threshold. The control mechanism can be set in such a way that the pyrotechnic actuator is triggered automatically when the predetermined energy input threshold is exceeded.

The system according to the invention may be capable of cutting a cable in the microsecond range, for example in 48 μs for an AWG (American Wire Gauge) 12 cable.

According to an exemplary further development of the system according to the invention, the pyrotechnic actuator comprises a mechanical primer for providing a pyrotechnic gas expansion. Mechanical primers may be characterized in that their activation is triggered by means of mechanical force, such as by a hit or by a shock. Mechanical primers may comprise an explosive that undergoes pyrotechnic conversion as a result of activation, in particular the application of mechanical force, and provides a pyrotechnic gas expansion. For example, the conversion of the explosive is initiated by a frictional force between the explosive and a force-transmitting member, such as a striker, that causes the mechanical force application.

In another exemplary embodiment of the present invention, the control mechanism comprises a preloaded, in particular spring-biased, force transmission member, such as a firing pin. The force transmission member may be preloaded, in particular spring-preloaded, in an initial position, i.e. in a non-activated position of the pyrotechnic actuator, and/or may comprise or temporarily store potential energy. When the predetermined energy input threshold is exceeded, the power transmission part is actuated, in particular to activate the mechanical primer. When the predetermined energy input threshold is exceeded, the force transmission member can release the potential energy temporarily stored as a result of the bias voltage. According to an exemplary further development, when the predetermined energy input threshold is exceeded, the preload is preferably abruptly released and/or transferred or delivered to the mechanical primer for its activation. For example, the preload can be abruptly released in such a way that, when the predetermined energy input threshold is exceeded, the potential energy provided in the form of the preload is immediately converted into kinetic energy and/or the force transmission member is immediately accelerated. For example, the power transmission part can be held in the preloaded position by a spring, which characterizes the initial position of the pyrotechnic actuator. If the energy input threshold is finally exceeded, the spring preload force acts directly on the force transmission member and accelerates it out of its initial position in the direction of the mechanical promer in order to activate it, in particular to bring about the pyrotechnic gas expansion.

According to an exemplary further embodiment of the present invention, the control mechanism further comprises a force storage for holding the force transmission member in its biased position. For example, the force storage may be implemented by the heat source according to any of the preceding aspects or exemplary embodiments. The force storage may counteract the bias, in particular the spring bias, preferably the spring force, in particular provide a counterforce to hold the force transmission member in the biased position, preferably as long as the predetermined energy input threshold is not exceeded. For example, the force storage is designed as a type of predetermined breaking point which is activated preferably abruptly when the predetermined energy input threshold is exceeded and, in particular, releases the force transmission member so that the force transmission member can release from the preloaded position. According to an exemplary further development, the force storage is arranged between the mechanical primer, in particular the force transmission member, and the spring.

In a further exemplary embodiment of the system according to the invention, the force storage is assigned to the force transmission member in such a way that when the predetermined energy input threshold is exceeded, the force storage releases the force transmission member. According to an exemplary further development, the force transmission member then performs an axial relative movement with respect to the pyrotechnic actuator, in particular with respect to the mechanical primer, wherein in particular the force transmission member strikes the mechanical primer. According to an exemplary further development, the force transmission member is designed in two parts and consists of a firing pin directly assigned to the pyrotechnic actuator and an acceleration part directly assigned to the force storage or the spring. When the predetermined energy input threshold is exceeded, the force storage releases the acceleration part, which is accelerated axially in the direction of the firing pin and finally strikes or impacts the firing pin. To activate the pyrotechnic actuator or the mechanical primer, the firing pin transfers the kinetic energy expended and generated by the acceleration part to the mechanical primer. For example, the force storage, which is preferably designed as a predetermined breaking point, is arranged between the firing pin and the acceleration part and/or keeps the acceleration part and the firing pin at a distance from each other in the initial position, which relates to the non-activated position of the pyrotechnic actuator. When the pyrotechnic actuator is activated, i.e. as a result of the predetermined energy input threshold being exceeded, the force storage, in particular the predetermined breaking point, releases the acceleration part so that it can move towards the firing pin. The acceleration part is guided axially by a chamber wall during its movement, for example. For example, the chamber wall forms at least part of a gearbox of the system according to the invention.

According to an exemplary further development of the system according to the invention, the preload of the force transmission member is realized by a spring, for example a spiral compression spring. The spring can be supported on the power transmission part, in particular on the acceleration part. At the other end of the spring, the spring can be supported on an outer housing of the system, the pyrotechnic actuator and/or the pyrotechnic cutting device.

According to an exemplary further embodiment of the system according to the invention, the kinetic energy input threshold is set in such a way that when an acceleration force threshold acting on the force storage is exceeded, in particular a negative acceleration force threshold, the force storage releases the force transmission member. The negative acceleration force threshold can be exceeded, for example, in the event of an impact and/or abrupt stop. When the acceleration force threshold is exceeded, a housing and/or a boundary separating a reaction substance from a reaction partner substance may break. For example, this is accompanied by mixing of the reaction substance and reaction partner substance, in particular under exothermic chemical reaction.

According to an exemplary further development of the system according to the invention, the thermal energy input threshold is set in such a way that when a predetermined ambient temperature of the force storage is exceeded, the force storage releases the force transmission member. For example, the control mechanism is implemented by a predetermined temperature resistance threshold of the force storage. For example, the temperature resistance threshold of the force storage can be understood as a material-specific temperature of a housing of the force storage. The temperature resistance threshold of the force storage housing is defined by the temperature up to which the housing remains stable and/or separates or shields the reaction partner substance from the reaction substance. When the temperature resistance threshold is exceeded, the force storage device releases the force transfer part, in particular by causing the housing or the boundary to melt. This can cause mixing of the reaction substance and the reaction partner substance.

According to an exemplary embodiment of the present invention, the control mechanism comprises an electrical primer element associated with the force storage device such that upon electrical initiation of the electrical primer element, the force storage device is activated to release the force transmission member. In particular, the control mechanism is formed by the electrical primer element. The electrical primer element, in particular an electrical primer element in the form of an electrical primer having a thermal or ignition bridge, is associated with the force storage in such a way that, upon electrical initiation of the electrical primer element, the force storage is activated to release the force transmission member. For example, it can be provided that the electrical primer element, in particular its ignition or thermal bridge, heats up in such a way that the housing or the boundary is destroyed in order to trigger mixing of the reaction substance and the reaction partner substance. For example, the electrical primer element of the control mechanism may be connected in series with at least one further control mechanism option, such as exceeding a predetermined kinetic and/or thermal energy input threshold, such that electrical initiation of the electrical primer element causes the energy input threshold to be exceeded so that, as a result, the force storage is activated to release the force transfer member.

In the following, further properties, features and advantages of the invention will become clear by means of a description of preferred embodiments of the invention with reference to the accompanying exemplary drawings and tables, in which show:

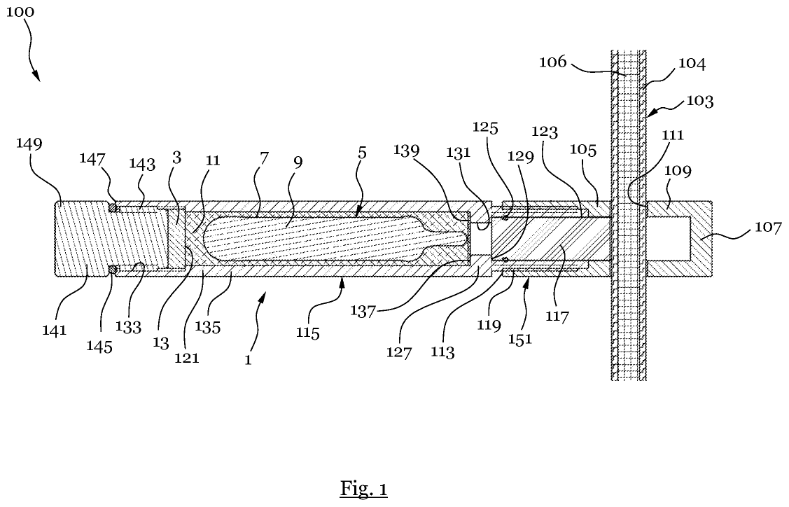

FIG. 1 a sectional view of a system according to the invention, which is part of a pyrotechnic cutting device;

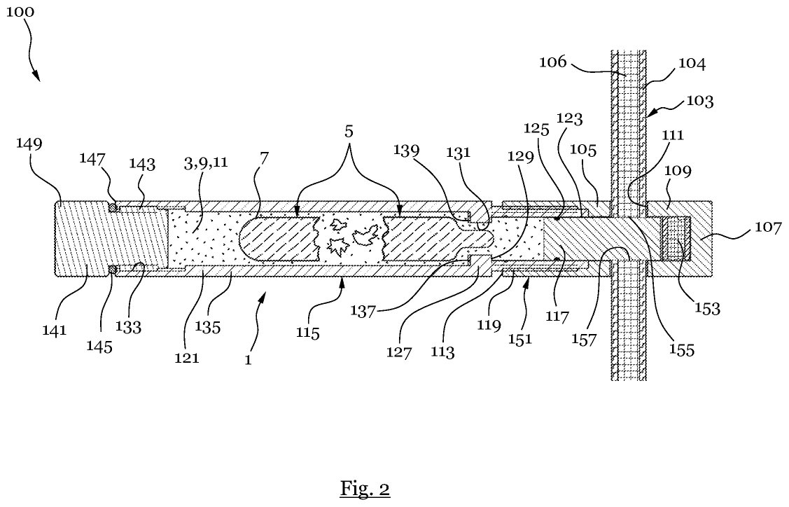

FIG. 2 a sectional view of the pyrotechnic cutting device according to FIG. 1 after provision of a predetermined pyrotechnic energy output by the system according to the invention;

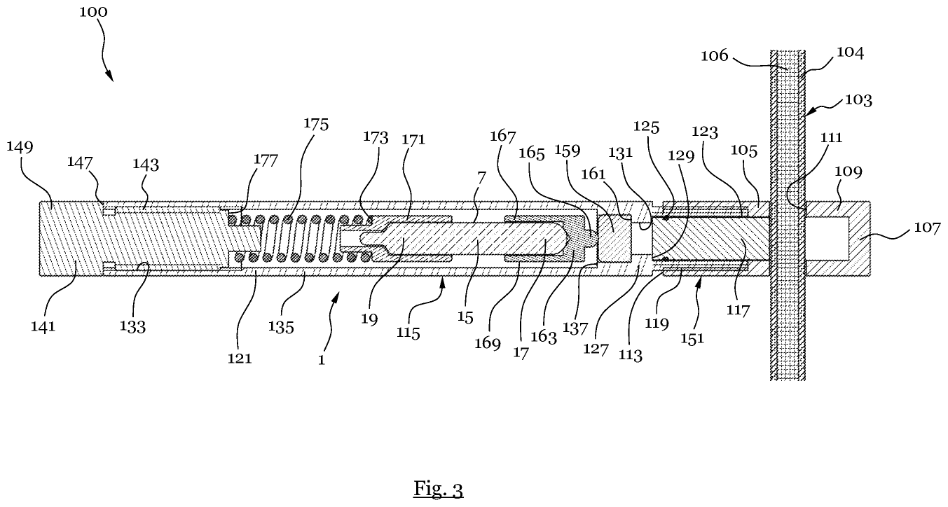

FIG. 3 a sectional view of a further exemplary design of a system according to the invention, which is part of a pyrotechnic cutting device;

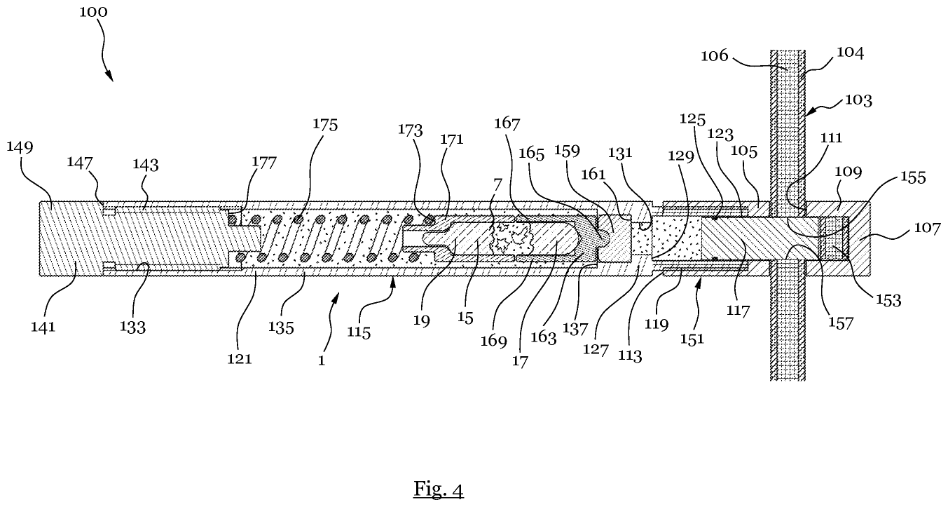

FIG. 4 a sectional view of the pyrotechnic cutting device according to FIG. 3 after provision of the predetermined pyrotechnic energy output by the system according to the invention;

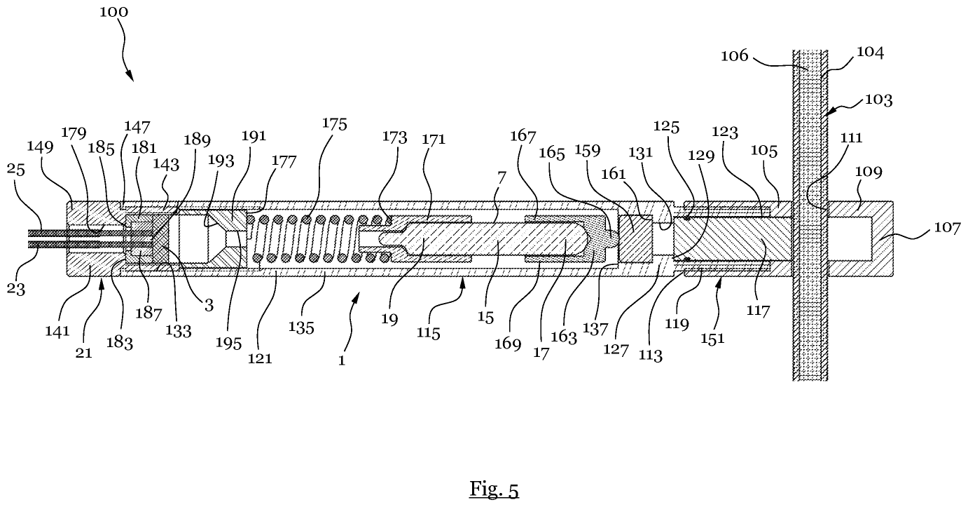

FIG. 5 a further exemplary design of a system according to the invention, which is part of a pyrotechnical cutting device;

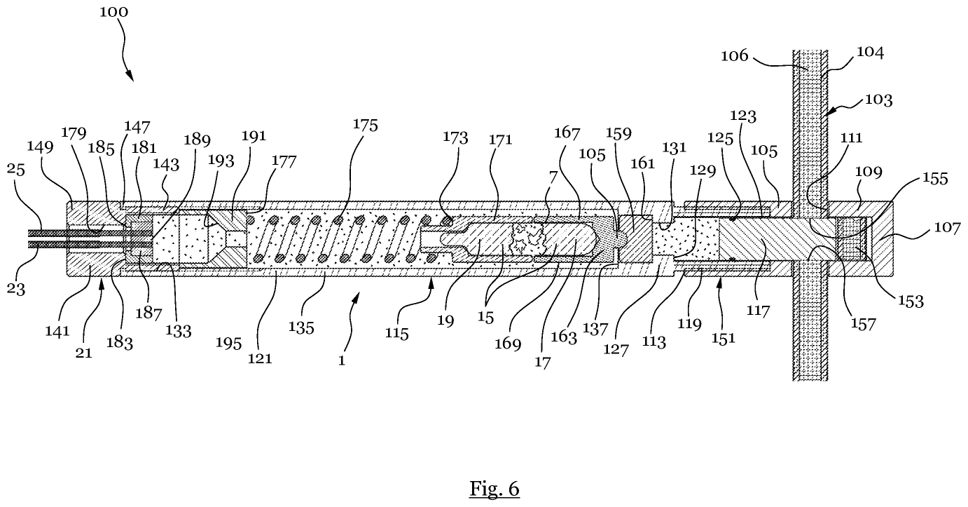

FIG. 6 a sectional view of the pyrotechnic cutting device according to FIG. 5 after the pyrotechnic energy output has been provided by the system according to the invention;

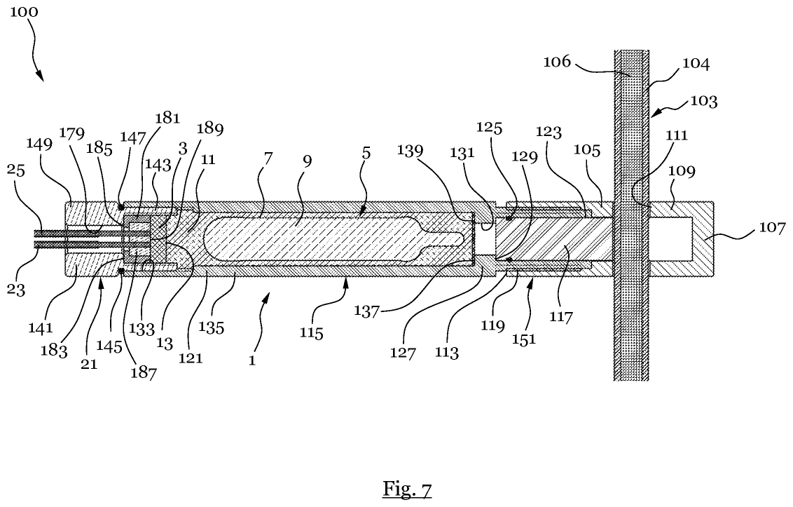

FIG. 7a a sectional view of a further exemplary embodiment of a system according to the invention, which is part of a pyrotechnic cutting device; and

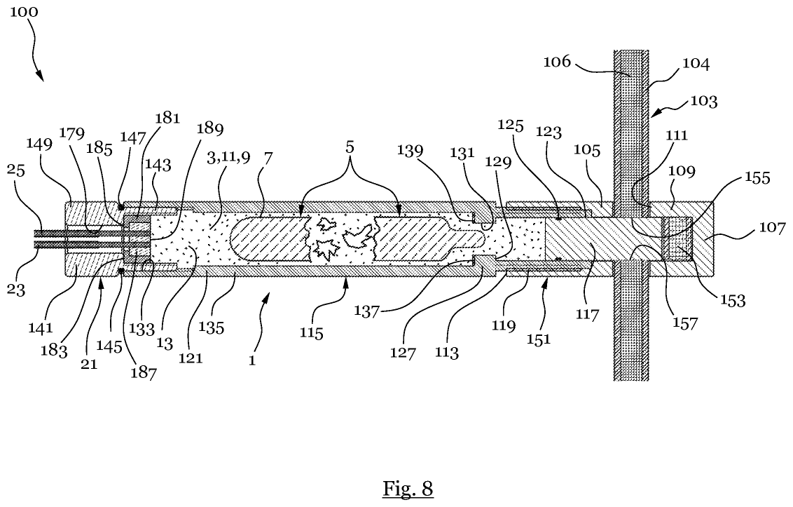

FIG. 8 a sectional view of the pyrotechnic cutting device of FIG. 7 after the pyrotechnic system has provided the pyrotechnic energy output.

In the following description of exemplary embodiments of systems according to the invention as well as process according to the invention, a system according to the invention is generally provided by the reference numeral 1. In the embodiments according to the accompanying figure pages, the system 1 according to the invention for providing a predetermined pyrotechnic energy output preferably of at least 0.5 J part in a pyrotechnic cutting device, which is generally provided by the reference numeral 100, for severing a strand-like or sheet-like element. In one embodiment of the invention, this integrates the severing of an electric line 103 leading to an electrical energy source (not shown), such as a battery or accumulator, for dissipating and/or receiving electrical energy, which may be, for example, one or a plurality of: a cable, a wire, a braid, a rope, a tube, a (glass) fiber with or without armor and/or sheathing, a conductor path, or a combination of the above examples, or the like. To avoid repetition, the separation of an electrical charge coupling of an electric line will be discussed below. However, it will be apparent to those skilled in the art that other string-like elements or sheet-like elements may also be severed. The pyrotechnic cutting device 100 is designed to disconnect, for example, an electrical charging coupling or an electrical discharging coupling transmitted via an electric line 103. The necessary energy for cutting an electric line 103, which for example comprises stranded wires 106 and an insulation jacket 104, is provided by means of the system 1 according to the invention. The necessary energy to be provided by the system 1 depends on the dimensioning of the cutting device 100 and, in particular, on the material, the material thickness and/or a line diameter and is to be set via a scaling or suitable design of the system 1 according to the invention. With reference to FIGS. 1-8, exemplary embodiments of systems 1 according to the invention are described, each of which is part of a pyrotechnic cutting device 100 and provides the pyrotechnic cutting device 100 with the energy required for cutting the, for example, electric line 103. In this context, identical or similar components are provided with identical or similar reference numerals. In order to avoid repetition, with respect to the various embodiments, in each case essentially only the differences arising with respect to the further embodiments will be discussed.

FIGS. 1 and 2 show a first embodiment of a system 1 according to the invention, wherein FIG. 1 shows the state of the pyrotechnic cutting device too before its activation and FIG. 2 shows the state of the pyrotechnic cutting device too after its triggering or activation. The pyrotechnic cutting device too comprises an elongated, hollow cylindrical housing 105, which is closed towards one longitudinal side. A substantially planar bottom wall 107 is provided on this longitudinal side. At a distal peripheral zone 109, the housing 105 has a passage duct tit oriented substantially perpendicular to the axial extent of the housing 105, through which the electric line 103 is passed. Facing the bottom wall 107, the housing 105 is open, having an opening 113 formed in the face. Partially inserted through the opening 113 into the interior of the housing 105 is a pyrotechnic actuator 115 configured to operate a cutting mechanism 117 axially movably disposed within the housing 105. In particular, the pyrotechnic actuator 115 provides the mechanical work necessary to cut the electrical wire 103, wherein the pyrotechnic actuator 115 utilizes the pyrotechnic effect. As shown schematically in FIG. 1, the pyrotechnic actuator is connected to the housing 105 in a gas- and pressure-tight manner by means of a keyed joint 119. The pyrotechnic actuator 115 includes a pressure-, fluid-, and/or gas-tight chamber 121 having a cutting mechanism-side case section 123 that is largely inserted into the interior of the housing 105 through the opening 113. The cutting mechanism 117, which may be, for example, a blade, a pin or a piston, a ball, a ram or a cutting edge and is preferably made of plastic, in particular hard plastic or also rubber, ceramic, glass or metal, is circumferentially surrounded both by the housing 105 and by the case section 123 and is guided during an axial movement both by the case section 123 and by the housing 105. On the inside, a sealing ring 125, in particular a plurality of sealing rings 125 arranged in series, is provided between the case section 123 and the cutting mechanism 117. It should be understood, however, that any conceivable means of sealing may be provided between case section 123 and cutting mechanism 117. For example, the cutting mechanism 117 may be configured such that it bears against the wall of the case section 123 when subjected to a compressive load, such as in the manner of a Minié bullet. The case section 123 opens into a radial flange 127, which is offset radially inwardly with respect to the case section 123 to form an axial annular support 129 for the cutting mechanism 117. This allows for simplified assembly, but is not essential to the operation of the present invention.

The chamber 121 is essentially an elongated component and is hollow cylindrical in shape with end passage opening 131, 133 (facing each other). Adjacent to the flange section 127 is a cylindrical section 135 having a wall thickness less than that of the flange section 127 and forming an (annular) support 137 opposite the (annular) support surface 129, on which an mounting aid 139 rests, provided for example in the form of a paper disc. The cylindrical section 135 defines a cylindrical cavity which is closed off at an opposite end with respect to the case section 123. To close it off, a plug-like bottom part 141 is inserted into the chamber 121 via the opening 133 and connected to the chamber 121 so that the interior is configured to be fluid, pressure and/or gas tight. The bottom part 141 may, for example, be attached to the chamber 121 by a screw joint, which is schematically indicated by means of the reference numeral 143, or by some other substance-locking or force-locking connection. Further, to increase sealing performance, a sealing ring 145 may be disposed at a front end 147 of the chamber 121 such that a head 149 of the bottom portion forms on the seal receptacle for the seal 145 together with the front end 147. Closed-loop joints, such as welding, bonding, or the like, are also conceivable.

The system 1 according to the invention may comprise the pyrotechnic actuator 115. The pyrotechnic actuator 115 and/or the system 1 comprise a pyrotechnic material 3 disposed within the chamber cavity, namely in the region of the bottom part 141. The pyrotechnic material 3 is adapted to pyrotechnically convert when a predetermined ambient temperature is exceeded. The pyrotechnic conversion of the pyrotechnic material 3 generally results in a gas expansion, due to which the pressure within the chamber 121 increases considerably, so that a force is exerted on the cutting mechanism 117, which moves axially relative to the chamber 121, in particular the case section 123, and the housing 105 as a result of the gas expansion, and in this way cuts, for example, the electric line 103 (see FIG. 2).

The pyrotechnic actuator 115 is coupled to the cutting mechanism 117 by means of a gear 151 for, in particular, transmission-free transmission of the drive force generated by the pyrotechnic actuator 115 to the cutting mechanism 117. The gear 151 comprises, for example, at least partially the chamber 121 in which the pyrotechnic material 3 is arranged, in particular an inner chamber wall, as well as the cutting mechanism housing 105, in particular those sections which are responsible for transmitting the force of the pyrotechnic actuator force to the cutting mechanism 117. For example, those sections are responsible or decisive for force transmission which guide the cutting mechanism 117 during its axial relative movement or are in contact with the cutting mechanism 117 substantially parallel to its direction of movement. The cutting mechanism 117 is associated with the pyrotechnic actuator 115 by means of the gear 151 in such a way that, when the pyrotechnic actuator 115 is activated or triggered by means of the gear 151, the cutting mechanism 117 is actuated and caused to perform an axial relative movement with respect to the housing 105 of the cutting mechanism and with respect to the case section 123 (see FIG. 2).

The system 1 according to the invention may comprise the chamber 121 or may be arranged in the chamber 121. The system 1 for providing a predetermined pyrotechnic energy output comprises a heat source 5 for delivering heat to the pyrotechnic material or pyrotechnic material 3. The heat source 5 may have, for example, a bottle-like or capsule-like structure or shape. The heat source 5 comprises a housing 7, for example made of glass, plastic or metal, in particular a metal alloy, such as a Rose alloy, for accommodating a reaction substance 9, preferably containing chemical energy. For example, the reaction substance comprises glycerol, zinc powder, ammonium nitrate, ammonium chloride and/or lithium aluminum hydride. Further, the heat source 5 comprises a reaction partner substance 11 separate from the reaction substance 9. According to FIG. 1, the reaction partner substance 11, which may comprise, for example, potassium permanganate, water and/or methanol, is separated from the reaction substance 9 by means of the housing 7 and is arranged within the chamber 121. Furthermore, according to the exemplary embodiment of FIGS. 1 and 2, the reaction partner substance 11 is separated from the pyrotechnic material 3 by means of a thin-walled boundary 13, such as a partition or layer. Direct mixing of pyrotechnic material 3 with reaction partner substance 11 is also possible.

According to the present invention, the heat source 5 is set to impart heat to the pyrotechnic material 3 when it is activated, so that the pyrotechnic material 3 at least partially reaches its pyrotechnic material-specific conversion temperature. The heat source 3 is controlled or triggered by a control mechanism associated with the heat source 5 for triggering the predetermined pyrotechnic energy output. The control mechanism is arranged to act on the heat source 5 for releasing its stored heat to the pyrotechnic material 3 at a predetermined operating condition at which an ambient temperature of the pyrotechnic material 3 has not yet reached the conversion temperature of the pyrotechnic material 3, such that the pyrotechnic material is heated to at least partially reach the conversion temperature. For example, the control mechanism may activate the heat source when a predetermined threshold of kinetic and/or thermal energy input acting on the control mechanism is exceeded.

According to the embodiment of FIGS. 1 to 2, the control mechanism is realized, for example, by a predetermined temperature resistance threshold of the heat source 5. The temperature resistance threshold of the heat source 5 is, for example, the temperature up to which the housing 7 of the heat source 5 remains stable and accordingly retains its shape and/or separates the reaction substance 9 from the reaction partner substance 11. If this temperature stability threshold of the housing 7 is exceeded, the heat source 5 is activated and heat is communicated to the pyrotechnic material 3.

As shown schematically in FIG. 2, the activation of the heat source 5 can be effected by the housing 7 breaking or at least partially melting, so that a mixing of reaction substance 9 and reaction partner substance 11 is accompanied. The reaction substance 9 and the reaction partner substance 11 are designed with respect to each other in such a way that when the two substances are mixed, in particular as a result of activation of the heat source 5, an exothermic chemical reaction is triggered and the resulting or generated heat is communicated to the pyrotechnic material 3. As it is also schematically indicated in FIG. 2, a state of the pyrotechnic cutting device too or the heat source 5 or the pyrotechnic material 3 is shown in which the heat source 5 has been activated by the control mechanism so that so much heat has been communicated to the pyrotechnic material 3 that the pyrotechnic material 3 has reacted, causing a gas expansion which has caused an axial relative movement of the cutting mechanism 117 to cap the, for example, electric line 103. Due to the broken heat source 5 or broken housing 7, a mixture of pyrotechnic material 3, reaction substance 9 and reaction partner substance 11 is partially present in chamber 121, together with combustion residues, such as NOₓ, CO_{y}, KO_{z} and/or CaO, formed during the pyrotechnic conversion of pyrotechnic material 3. It should be understood that there are predominantly residues of the reaction products of reaction substance 9 and reaction partner substance 11. The residues of reaction substance 9 and reaction partner substance 11 themselves are only present to a small extent, if at all, since substances 9, 11 consume themselves during the reaction.

In an analogous manner, the control mechanism can be realized by an acceleration force threshold acting on the heat source 5, in particular a negative acceleration force threshold. For example, an abrupt impact or collision can form such an acceleration force threshold, in particular a negative acceleration force threshold. As a result of the acceleration force threshold being exceeded, the heat source 5 is activated by its housing 7 breaking as a result of the force acting on the housing 7. The shattering, dissolving or bursting of the housing 7 results in an analogous way in a mixing of the reaction substance 9 and the reaction partner substance 11, which results in the previously described heating of the pyrotechnic material 3 and the associated activation of the pyrotechnic actuator 115. The activation of the pyrotechnic cutting device too results in the electric line 103 being capped by the cutting mechanism 117. As shown in FIG. 2, the cutting mechanism 117 cuts the electric line 103 by severing a line section 153 from the remainder of the line 103 and displacing it into the distal peripheral zone 109 of the housing 105. If the cutting mechanism is made of an electrically non-conductive material, such as plastic, the cutting mechanism acts as a type of insulator between the facing electric line ends 155, 157.

With regard to the exemplary embodiments shown according to the enclosed figure pages, it should be noted that the pyrotechnic cutting device too, the pyrotechnic actuator 115 and the system 1 are scalable in their dimensions, preferably in order to cut differently dimensioned (electrical) lines 103 or to provide differently sized pyrotechnic energy output quantities. Furthermore, also their outer shape, in particular cross-sectional dimension, is not limited to a specific shape and/or dimension, but can be adapted depending on the application or installation situation, for example, of the pyrotechnic cutting device 100 in or on an electrical appliance not shown. The passage duct 111 is to be dimensioned and thereby adapted to the external dimensions of the electric line 103 in such a way that the electric line 103 can be passed through the passage duct 111.

With reference to FIGS. 3 and 4, a further exemplary embodiment of a system 1 according to the invention is explained, which is integrated into a pyrotechnic cutting device 100, which has substantially the same structure as that of FIGS. 1 and 2, respectively.

According to the embodiment according to FIGS. 3 and 4, the system 1 comprises the pyrotechnic actuator 115. In contrast to the embodiment according to FIGS. 1 and 2, the pyrotechnic actuator 115 comprises a mechanical priming cap 159 for providing a pyrotechnic gas expansion. The mechanical priming cap 149 is arranged in the region of the flange section 127, which is dimensioned larger in the longitudinal extension direction of the chamber 121 or the housing 105 and/or in the movement direction of the cutting mechanism 117, compared to the embodiment according to FIGS. 1 and 2. Facing the pyrotechnic actuator, the flange section 127 has a radially recessed ring support portion 161 on which the mechanical primer 159 rests. The primer 159 is held axially in position by a preloaded, in particular spring-preloaded, force transmission member, which is formed by a firing pin 163 with a nose-like, convexly curved protrusion 165, which points in the direction of the mechanical primer 159. The firing pin 163 has a substantially U-shaped structure, with a receiving space formed between two opposing legs 167 and 169 in which the force storage 15 is partially received.

The force storage 15 may be formed, for example, by the previously described heat source 5. The legs 167, 169 of the firing pin 163 surround a front end 17 of the force storage 15, which has a rear end 19 surrounded by a movable acceleration part 171 axially offset with respect to the firing pin 163. The acceleration part 171 comprises an at least partially hollow cylindrical structure. Together with the firing pin 163, the acceleration part 171 forms the force transmission member of the control mechanism. A spring, for example a spiral compression spring 175, is supported on an end face 173 of the acceleration part 171 facing in the direction of the bottom part 141 and is responsible for the spring bias of the force transmission member 163. The spiral compression spring 175 is also supported on an end face 177 of the bottom part 141 facing into the interior of the chamber.

In FIG. 3, a depressed, preloaded position of the spiral compression spring 175 is shown, in which energy is stored. In contrast to the embodiment according to FIGS. 1 and 2, in the embodiment according to FIGS. 3 and 4, no pyrotechnic material 3 is arranged in the chamber 121. According to the embodiment according to FIGS. 3 and 4, the pyrotechnic gas expansion is generated exclusively by the mechanical primer 159. The control mechanism according to the embodiment shown in FIGS. 3 and 4 is configured to initiate the pyrotechnic actuator 115 when a kinetic and/or thermal energy input acting on the control mechanism exceeds a predetermined energy input threshold. When the predetermined energy input threshold is exceeded, the pyrotechnic actuator 115 is activated by releasing the bias of the spiral compression spring 175, preferably abruptly, and releasing the stored energy, preferably abruptly, so that the firing pin 163 strikes the mechanical primer 159 to activate it. Activation of the mechanical primer causes pyrotechnic gas expansion (FIG. 4), which in turn, as has already been described with respect to FIGS. 1 and 2, drives the cutting mechanism 117 to cut the electrical wire 103, for example. Activation of the mechanical primer 159 is accomplished by actuating the acceleration part 171, which is held in position and at a distance from the firing pin 163 by the force storage 15 and is biased toward the firing pin 163 by the spiral compression spring 175. This can be done by the energy input threshold being implemented by an acceleration force, in particular negative acceleration force, acting on the force storage 15. For example, the acceleration force threshold can be caused by an abrupt fall or impact. As a result of the acceleration force threshold being exceeded, the force storage releases the acceleration part 171 so that it is accelerated by the spiral compression spring 175 and strikes the firing pin 163, which then strikes the mechanical primer 159 to activate it. For example, the force storage 15 has a housing made of, for example, glass, plastic or metal, particularly a metal alloy such as Roshe's alloy. Thus, if the acceleration force threshold is exceeded, the housing 7 of the force storage 15 shatters, causing a chain reaction: Release of the preload force; axial acceleration of the acceleration part 171; impact of the acceleration part 171 on the firing pin 163; impact of the firing pin 163 on the mechanical primer 159; activation of the mechanical primer 159 under pyrotechnic gas expansion; operation of the cutting mechanism 117 to cut the electric line 103 (FIG. 4).

In an analogous manner, the control mechanism can also be implemented by a thermal energy input threshold with respect to the force storage 15, so that when a predetermined ambient temperature of the force storage 15 is exceeded, the force storage 15 releases the force transmission member 163 in an analogous manner. For example, this can be done by the housing 7 of the force storage 15 melting, breaking or partially dissolving when the predetermined temperature threshold is exceeded, so that the acceleration part 171 is accelerated in the direction of the firing pin 163 by the spiral compression spring 175 as a result of the spring biasing force acting on it.

The embodiment according to FIGS. 5 and 6 corresponds essentially to the embodiment of FIGS. 3 and 4, with the system 1 additionally comprising an electrical primer element 21. In FIGS. 5 and 6, the electrical primer element 21 is configured as an electrical primer element. The electrical primer element 21 comprises electrical connection lines 23, 25, via which the electrical primer element 21 can be electrically activated. The electrical initiation of the pyrotechnic actuator 115 or the pyrotechnic energy output is characterized in that a heat input for the pyrotechnic material 3 associated with the electric trigger element 21 is provided via the electrical initiation, so that the conversion temperature of the pyrotechnic material 3 is exceeded to convert it. The electrical initiation may additionally be provided to provide a further initiation option for capping the electric line 103.

For example, a passage bore 179 is provided in the bottom part 141 through which the electrical connection lines 23, 25 extend. Furthermore, a hollow case 181, for example made of metal and/or in the form of a ring, is arranged in the interior of the base part 21, which case is also provided on a base-side end face 183 having a passage bore 185 for passing through the electrical connection lines 23, 25. Inside the case 181, a substantially fully cylindrical body 187 made of glass, for example, is arranged into which the electrical connection lines 23, 25 open. An ignition or thermal bridge 189, not shown in more detail, is provided on the body 187. The ignition or thermal bridge 189 is implemented, for example, as an ohmic resistor which heats up during the electrical initiation of the electrical primer element 21 in such a way that the pyrotechnic material 3, which rests on the ignition bridge 189 or is arranged in the immediate vicinity thereof, is heated in such a way that it converts in order to generate the pyrotechnic gas expansion for operating the cutting mechanism 117.

Furthermore, it is conceivable that the force storage 15 is actuated or released, in particular destroyed, via the electrical initiation by the electrical primer element 21 (see FIG. 6), so that the chain reaction described with reference to FIGS. 3 to 4 can be accompanied. According to the embodiment of FIGS. 5 and 6, an fitting piece 191, which is essentially hollow-cylindrical but may also be polygonal or elliptical in cross-section, is arranged between the bottom part 141 and the acceleration part 171, on which the spiral compression spring 175 is supported. The fitting piece 191 is adapted externally to an interior dimension of the chamber interior 121. The fitting piece defines a funnel-shaped section 193 in its interior, which opens into a substantially cylindrical bore or duct 195 through which pyrotechnic gas expansion can selectively propagate toward the cutting mechanism 117.

FIGS. 7 and 8 show another exemplary embodiment of a pyrotechnic cutting device 100 comprising a further embodiment of a system 1 according to the invention, substantially corresponding to the embodiment according to FIGS. 1 and 2, wherein the system 1 of FIGS. 7 and 8 additionally comprises an electrical primer element 21 described with reference to FIGS. 5 and 6 to provide the additional electrical initiation option described above.

TABLE 1
List of chemicals of the invention

| Trivial name/lab | | CAS |
|---|---|---|
| jargon | Plain name | number |
| K-benzanate (KDNBF) | Potassium dinitrobenzofuroxanate | 29267-75-2 |
| | (Potassium salt of 1,4-dihydro-5,7- | |
| | dinitrobenzofurazan-4-ol 3-oxide) | |
| Diazol, Dinol, DDNP | Diazodinitrophenol | 4682-03-5 |
| Lead styphnate, | Lead 2,4,6-trinitroresorcinate | 15245-44-0 |
| trizinate | | |
| Tetryl | N-methyl-N-2,4,6-tetranitroaniline | 479-45-8 |
| Picrazole | 1-(2,4,6-Trinitrophenyl)-5-(1 - | unknown |
| | (2,4,6-trinitrophenyl)-1 H-tetrazol- | |
| | 5-yl)-1 H-tetrazole | |
| K/CaStype | K/Ca 2,4,6-trinitrobenzene-1,3- | unknown |
| | bis(olate) | |
| Glycerin | Propane-1,2,3-triol | 56815 |
| Ammonium nitrate | NH₄NO₃ | 6484-52-2 |
| Ammonium chloride | NH₄Cl | 12125-02-9 |
| Lithium aluminum | LiAlH₄ | 16853-85-3 |
| hydride | | |
| Potassium | KMnO₄ | 7722-64-7 |
| permanganate | | |
| Methanol | CH₄ OH | 67-56-1 |

The features disclosed in the foregoing description, figures, and claims could be relevant both individually and in any combination for the realization of the invention in the various embodiments.

### LIST OF REFERENCE SIGNS

1 system
3 pyrotechnic material
5 heat source
7 housing
9 reaction substance
11 reaction partner substance
13 boundary
15 force storage
17, 19 end
21 electrical primer element
23, 25 electrical connection line
100 pyrotechnic cutting device
103 electric line
104 insulation jacket
105 housing
106 stranded wire
107 bottom wall
109 peripheral zone
111 passage duct
113 opening
115 pyrotechnic actuator
117 cutting mechanism
119 keyed joint
121 chamber
123 case section
125 sealing ring
127 radial flange
129 support
131, 133 passage opening
135 cylindrical section
137 support
139 mounting aid
141 bottom part
143 screwed joint
145 seal
147 end
149 head
151 gear
153 heat source
155, 157 line end
159 mechanical primer
161 ring support section
163 force transmission member/firing pin
165 protrusion
167, 169 leg
171 force transmission member/acceleration part
173 end face
175 compression spring
177 end face
179 passage bore
181 case
183 face
185 passage bore
187 body
189 ignition or thermal bridge
191 fitting piece
193 funnel-shaped section
195 duct

1. Process for providing a predetermined pyrotechnic energy output, wherein:
a pyrotechnic material is provided which pyrotechnically converts at a material-specific conversion temperature; and
to convert the pyrotechnic material at an ambient temperature of the pyrotechnic material, which is lower than the conversion temperature, heat is communicated to the pyrotechnic material.

2. Process according to claim 1, wherein the pyrotechnic material is heated to at least partially reach the conversion temperature.

3. Process according to claim 1, in which the pyrotechnic material is heated in such a way that a temperature difference between the conversion temperature and the ambient temperature is completely bypassed, in particular exceeded, preferably by at least 5°, at least 10°, at least 15°, at least 50°, at least 70° C. or by at least 90° C.

4. Process according to claim 1, wherein the heat is generated by an exothermic chemical reaction.

5. Process according to claim 1, wherein a reaction substance and a reaction partner substance are mixed, preferably under exothermic chemical reaction, to generate heat.

6. Process according to claim 5, wherein the reaction substance is selected from a list comprising glycerol, zinc powder, ammonium nitrate, ammonium chloride and/or lithium aluminum hydride, and the reaction partner substance is selected from a list comprising potassium permanganate, water and/or methanol.

7. Process according to claim 5, wherein a boundary separating the reaction substance and the reaction partner substance is melted, broken, punctured or the like.

8. Process according to claim 5, in which heat is communicated to the pyrotechnic material when a predetermined threshold of a kinetic and/or thermal energy input acting on the pyrotechnic material is exceeded.

9. Process according to claim 8, wherein the energy input threshold is realized by a temperature threshold and/or an acceleration force threshold.

10. Process according to claim 8, in which the communication of heat to the pyrotechnic material is electrically triggered.

11. Process, according to claim 8, for triggering a pyrotechnic actuator, in which the pyrotechnic actuator is triggered when a kinetic and/or thermal energy input acting on the pyrotechnic actuator exceeds a predetermined energy input threshold.

12. Process according to claim 11, wherein the initiation of the pyrotechnic actuator is initiated by mechanical force input to the pyrotechnic actuator, wherein in particular the mechanical force necessary to trigger the initiation of the pyrotechnic actuator is temporarily stored and when the predetermined energy input threshold is exceeded, the temporarily stored mechanical force is released, preferably abruptly.

13. Process according to claim 11, wherein the energy input threshold is realized by a temperature threshold and/or an acceleration force threshold.

14. Process according to claim 11, wherein exceeding the predetermined energy input threshold is initiated electrically.

15. Process according to claim 11, which proceeds according to the operation of the system formed according to claim 16.

16. System for providing a predetermined pyrotechnic energy output, comprising:
pyrotechnic material that pyrotechnically converts when a pyrotechnic material-specific conversion temperature is reached;
a heat source for delivering heat to the pyrotechnic material; and
a control mechanism associated with the heat source for triggering the predetermined pyrotechnic energy output, wherein the control mechanism acts at a predetermined operating condition, in which a conversion temperature of the pyrotechnic material has not yet reached the conversion temperature, on the heat source to release its stored heat, such that the pyrotechnic material is heated to at least partially reach the conversion temperature.

17. System according to claim 16, wherein the heat stored in the heat source is adjusted such that it completely bridges, in particular exceeds, a temperature difference between the conversion temperature and the ambient temperature when the heat source is activated, preferably by at least 5°, at least 10°, at least 15°, at least 50°, at least 70° C. or by at least 90° C.

18. System according to claim 16, wherein the heat source comprises an energy carrier containing chemical energy and activation of the heat source causes an exothermic chemical reaction of the energy carrier.

19. System according to claim 16, wherein the heat source comprises a reaction substance that is separated from a reaction partner substance disposed in the heat source or outside the heat source, wherein activation of the heat source is accompanied by mixing of the reaction partner substance and the reaction substance such that an exothermic reaction is triggered.

20. System according to claim 16, wherein the heat source comprises a reaction substance and a reaction partner substance disposed separately therefrom, wherein the reaction substance comprises glycerol, zinc powder, ammonium nitrate, ammonium chloride, and/or lithium aluminum hydride, and the reaction partner substance comprises potassium permanganate, water, and/or methanol.

21. System according to claim 16, wherein the heat source comprises a reaction substance separated from a reaction partner substance arranged in the heat source or outside the heat source, and a housing for receiving the reaction substance and optionally the reaction partner substance, wherein the reaction partner substance is separated from the reaction substance by the housing or optionally by a boundary formed inside the housing, for example of glass, plastic or metal, in particular a metal alloy.

22. System according to claim 21, wherein the housing and optionally the boundary is/are designed in such a way that, in the predetermined operating state a mixing of reaction substance and reaction partner substance is accompanied, in particular the housing and optionally the boundary is melted, broken, punctured.

23. System according to claim 16, wherein the heat source comprises a reaction substance and a reaction partner substance arranged separately therefrom, wherein the reaction partner substance is present with respect to the reaction substance in a ratio of at least 1:1, preferably at least 1.5:1 or at least 2:1 and/or of at most 5:1, preferably at most 4:1 or 3:1, wherein in particular the ratio is within the range from 1.5:1 to 2.5:1.

24. System according to claim 16, wherein the heat source comprises a reaction substance and a reaction partner substance arranged separately therefrom, wherein the reaction partner substance and the pyrotechnic material are at least partially mixed, wherein in particular there is a mixing ratio of reaction partner substance to pyrotechnic material of at least 10:1, in particular at least 15:1, at least 20:1 or at least 25:1.

25. System according to claim 16, wherein the control mechanism activates the heat source when a predetermined threshold of kinetic and/or thermal energy input acting on the control mechanism is exceeded.

26. System according to claim 16, wherein the control mechanism is implemented by a predetermined temperature resistance threshold of the heat source, so that when the temperature resistance threshold is exceeded, the heat source is activated, in particular by the housing or the partition wall breaking, melting or being penetrated, so that mixing of the reaction substance and the reaction partner substance is accompanied.

27. System according to claim 16, wherein the control mechanism is implemented by an acceleration force threshold acting on the heat source, in particular negative acceleration force threshold, so that when the acceleration force threshold of the heat source is exceeded, the heat source is activated, in particular by the housing or the boundary breaking, so that mixing of reaction substance and reaction partner substance is accompanied.

28. System according to claim 16, wherein the control mechanism comprises an electrical primer element associated with the heat source such that upon electrical initiation of the electrical primer element, the heat source is activated, in particular the electrical primer element heats up such that the housing or boundary is destroyed to trigger the mixing of the reaction substance and reaction partner substance.

29. System, in particular according to claim 16, for providing a predetermined pyrotechnic energy output, comprising:
a pyrotechnic actuator system; and
a control mechanism that triggers the pyrotechnic actuator when a kinetic and/or thermal energy input acting on the control mechanism exceeds a predetermined energy input threshold.

30. System according to claim 29, wherein the pyrotechnic actuator comprises a mechanical primer for providing a pyrotechnic gas expansion.

31. System according to claim 29, wherein the control mechanism comprises a preloaded, in particular spring-biased, force transmission member, such as a striker, which is actuated when the predetermined energy input threshold is exceeded, in particular in order to activate the mechanical primer, wherein, in particular when the predetermined energy input threshold is exceeded, the preload is preferably abruptly released.

32. System according to claim 29, wherein the control mechanism comprises a force storage, which is in particular heat source-realized, for holding the force transmission member in its biased position.

33. System according to claim 32, wherein the force storage is assigned to the force transmission member in such a way that, when the predetermined energy input threshold is exceeded, the force storage releases the force transmission member, wherein in particular the force transmission member performs an axial relative movement with respect to the pyrotechnic actuator, in particular strikes the mechanical primer.

34. System according to claim 31, wherein the prestressing of the force transmission member is realized by a spring, in particular a spiral compression spring, which is supported in particular on the force transmission member.

35. System according to claim 29, wherein the kinetic energy input threshold is set such that when an acceleration force threshold acting on the force storage, in particular negative acceleration force, is exceeded, the force storage releases the force transmission member, wherein in particular the force storage has a housing which breaks when the acceleration force is exceeded.

36. System according to claim 29, wherein the thermal energy input threshold is set in such a way that when a predetermined ambient temperature of the force storage is exceeded, the force storage releases the force transmission member, wherein in particular the force storage has a housing which melts when the predetermined temperature threshold is exceeded.

37. System according to claim 29, wherein the control mechanism comprises an electrical primer element associated with the force storage such that upon electrical initiation of the electrical primer element, the force storage is activated to release the force transmission member.
